(19) United States
(12) Patent Application Publication
(10) Pub. No.: US 2021/0270614 A1
(43) Pub. Date: Sep. 2, 2021

(54) METHOD OF LOCATING A VEHICLE

(71) Applicant: RENAULT s.a.s., Boulogne-Billancourt (FR)

(72) Inventors: Johann MOUSAIN, Germainville (FR); Marie-Anne MITTET, Palaiseau (FR); Mariama SARR, Montigny Le Bretonneux (FR)

(73) Assignee: RENAULT s.a.s., Boulogne-Billancourt (FR)

(21) Appl. No.: 17/260,117

(22) PCT Filed: Jul. 15, 2019
(86) PCT No.: PCT/EP2019/068952

§ 371 Date: Jan. 13, 2021

(30) Foreign Application Priority Data
Jul. 17, 2018 (FR) 18 56614

(51) Int. Cl. G01C 21/32; G01S 5/02; G01S 19/48; G01S 11/06; H04W 4/40; H04W 4/02

(52) U.S. Cl. CPC G01C 21/32; G01S 5/0263; H04W 4/023; G01S 11/06; H04W 4/40; G01S 19/48

(57) ABSTRACT

A method for locating a vehicle includes determining a first estimate of the position of the vehicle based on the determination of the relative position of the vehicle with respect to a roadside unit used as a first information source. The first estimate of the position of the vehicle is used to validate at least one second estimate of the position of the vehicle provided by at least one second information source.

The invention relates to a method for locating a vehicle, in particular a motor vehicle. The invention also relates to a communicating box intended to be used in a motor vehicle, and comprising means for implementing such a method. The invention further relates to a motor vehicle comprising such a box. The invention also relates to a computer program implementing such a method. The invention further relates to a storage medium on which such a program is recorded. Lastly, the invention relates to a signal from a data medium, carrying such a program.

With the advent of autonomous driving in the automotive industry, the requirements in terms of locating vehicles are becoming increasingly stringent.

To locate a vehicle, there are solutions such as GNSS (Global Navigation Satellite System) systems, RFID (Radio-frequency Identification) beacons, RTK (Real-time Kinematic) systems, trackers. However, these systems, which are usually used individually, do not allow the position of a vehicle to be determined with sufficiently high accuracy. Specifically, the environment around the vehicle may interfere with the determination of the position of the vehicle. For example, obstacles may be present between the transmitter, usually one or more satellites, and the receiving vehicle. This results in differences in accuracy in the determination of the position of the vehicle. RTK systems allow the position of a vehicle to be determined with a high degree of accuracy. However, a drawback of such RTK systems is their high cost of implementation and maintenance.

When a vehicle is used in manual mode, the location of the vehicle may be determined with lower accuracy, since the driver keeps “control of the wheel”.

However, when a vehicle is used in autonomous mode, driving is partially or completely entrusted to the vehicle. Differences in accuracy in the location of the vehicle may then have an effect on the decision-making of the vehicle. In addition, the information on the location of the vehicle is used by other systems, in particular by mapping systems. The inaccuracies in the location of the vehicle may well then be reflected in these systems. This may potentially seriously affect road safety and the reliability of autonomous driving.

Autonomous mode requires accurate location of the vehicle with respect to its traffic lane and with respect to the road environment through which the vehicle is moving. In autonomous mode, the accuracy required for positioning the vehicle is for example between approximately 0.5 m and approximately 1 m in the longitudinal direction and is for example between approximately 10 cm and approximately 15 cm in the lateral direction. What is meant by “longitudinal direction” is the main direction of the traffic lane in which the vehicle is traveling. What is meant by “lateral direction” is a direction perpendicular to the main direction of the traffic lane.

One method for locating a vehicle is known from the document “A roadside unit-based localization scheme for vehicular ad hoc networks” (Chia-Ho Ou, Department of Computer Science & Information Engineering, National Pingtung Institute of Commerce, Pingtung, Taiwan).

The objective of this method is to locate a vehicle on the basis of roadside units (RSUs) by exploiting the characteristics of the signals transmitted by the roadside units, mainly the times of arrival and the differences in times of arrival of the signals. In this document, to estimate the position of the vehicle, information coming from two RSUs located on either side of the roadway is used, while taking into account the odometric data of the vehicle. This makes it possible to estimate two possible positions of the vehicle, then to determine the position of the vehicle by applying an algorithm.

However, this solution has drawbacks. In particular, such a method requires the use of pairs of RSUs located on either side of the roadway. However, current infrastructures are rarely equipped with pairs of RSUs located on either side of the roadway. Current infrastructures are generally equipped with RSUs arranged on just one side of the roadway. The implementation of such a method would therefore require many changes to the existing road infrastructures or those currently being designed. Furthermore, such a method requires the use of a high number of RSUs. This results in a high cost of implementation of such a method.

The aim of the invention is to provide a method for locating a vehicle that overcomes the above drawbacks and improves on the methods for locating a vehicle known from the prior art. In particular, the invention aims to provide a method making it possible to locate a vehicle with improved accuracy and reliability, while limiting costs.

To achieve this objective, the invention relates to a method for locating a vehicle, comprising a step of determining a first estimate of the position of the vehicle on the basis of determining the relative position of the vehicle with respect to a roadside unit used as a first information source, said first estimate of the position of the vehicle being used to validate at least a second estimate of the position of the vehicle provided by at least a second information source.

The step of determining the first estimate of the position of the vehicle may comprise the reception by the vehicle of at least one message transmitted by said roadside unit.

The reception by the vehicle of at least one message transmitted by said roadside unit may comprise obtaining raw data and/or formatting the raw data.

The reception by the vehicle of at least one message transmitted by said roadside unit may further comprise a filtering so as to take into account only the messages transmitted by a roadside unit.

The step of determining the first estimate of the position of the vehicle may further comprise measuring the power of the signal carrying the message and/or a step of determining the relative position of the vehicle with respect to said roadside unit, on the basis of the detection of a maximum power reached by said signal.

The step of determining the relative position of the vehicle with respect to said roadside unit may include considering that, when the signal reaches the maximum power, the vehicle is located on the road on the side of which the roadside unit is known to be installed, at the point on this road closest to said unit.

Advantageously, the power of the signal carrying the messages is measured so as to determine the minimum distance dₘᵢₙ from the vehicle with respect to the roadside unit.

The RSSI of the signal may be used as a location datum for the vehicle.

The step of determining the first estimate of the position of the vehicle may comprise a step of determining the time t_{ref} required for the vehicle to reach a reference position.

The step of determining the time t_{ref} required for the vehicle to reach a reference position may comprise the following sub-steps:
determining a reference position corresponding to the position at which the vehicle is located the shortest possible distance away from the roadside unit;
determining the current position, the speed in real time and the direction of the vehicle;
calculating the time t_{ref} required for the vehicle to reach said reference position, on the basis of said reference position, by considering the current position, the speed in real time and the direction of the vehicle.

The sub-step of determining the current position, the speed in real time and the direction of the vehicle may comprise:
obtaining first data comprising a first current position and/or a first speed in real time and/or a first direction of the vehicle, on the basis of the reception of messages transmitted by said roadside unit;
receiving messages transmitted by at least a second information source, making it possible to obtain second data comprising a second current position and/or a second speed in real time and/or a second direction of the vehicle;
comparing the first data obtained from said roadside unit and the second data obtained from the at least a second information source, making it possible to determine the current position of the vehicle and/or the speed in real time of the vehicle and/or the direction of the vehicle, or to construct the current position of the vehicle and/or the speed in real time of the vehicle and/or the direction of the vehicle, according to the first and second data.

The step of determining the first estimate of the position of the vehicle may comprise a step of filtering, in particular with respect to a map.

The information provided by the first information source may conform to the 802.11p Wi-Fi standard.

The invention also relates to a communicating box intended to be used in a vehicle, the communicating box comprising hardware and/or software elements implementing a method of the type described above, in particular hardware and/or software elements designed to implement a method of the type described above, and/or the communicating box comprising means for implementing a method of the type described above.

The invention further relates to a data storage medium, readable by a computer, on which is stored a computer program comprising program code instructions for implementing a method of the type described above, or to a computer-readable storage medium comprising instructions which, when they are executed by a computer, lead this computer to implement a method of the type described above.

The invention also relates to a vehicle comprising a box of the type described above and/or a medium of the type described above.

The invention further relates to a computer program product comprising program code instructions stored on a computer-readable medium for implementing the steps of a method of the type described above when said program is operating on a computer or computer program product that is downloadable from a communication network and/or stored on a data medium that is readable by a computer and/or executable by a computer, comprising instructions which, when the program is executed by a computer, lead this computer to implement a method of the type described above.

Lastly, the invention relates to a signal from a data medium, carrying a computer program product of the type described above.

The appended drawings show, by way of example, one embodiment of a method for locating a vehicle according to the invention.

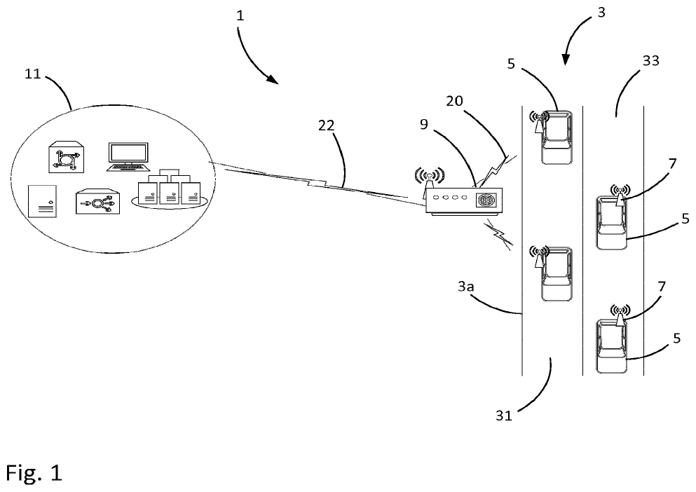

FIG. 1 schematically shows a road infrastructure equipped with a roadside unit (RSU).

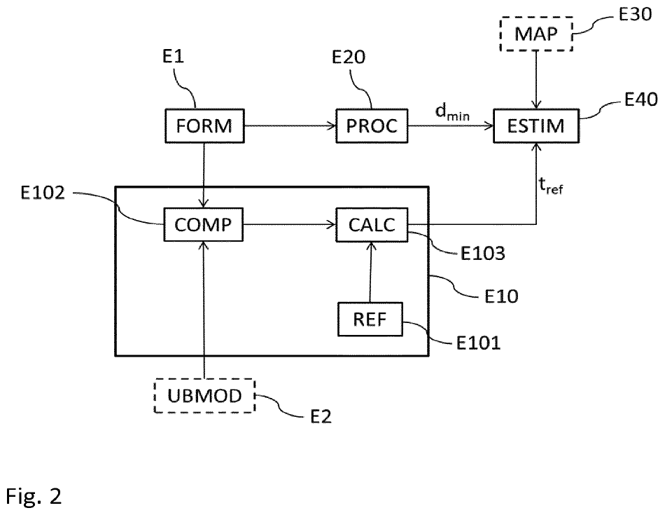

FIG. 2 shows a flowchart of one embodiment of a method for locating a vehicle.

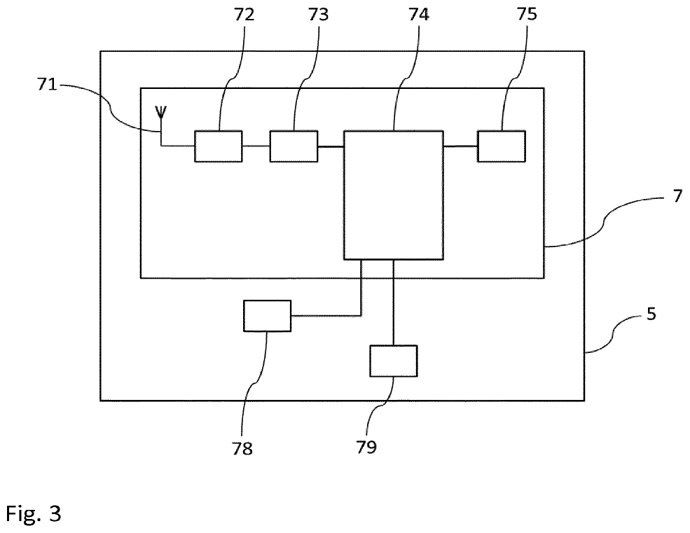

FIG. 3 schematically shows one embodiment of a vehicle.

Accurately locating a vehicle, in particular an autonomous vehicle, requires the combined use of a plurality of information sources. The invention aims to exploit the existing road infrastructure or that currently being constructed. There are devices or units called roadside units (RSUs). These RSUs are usually only used for communications between vehicles and infrastructures, called V2I (vehicle-to-infrastructure) communications. These RSUs allow event information to be relayed to vehicles or between vehicles and infrastructures. The invention proposes a method for locating a vehicle using roadside units as an additional information source in order to improve the determination of the position of the vehicle, in particular in order to improve the accuracy and/or reliability of the location of the vehicle. The use of the existing road infrastructure or that currently being constructed makes it possible to limit the costs of implementation of such a method for locating a vehicle.

One example of a road infrastructure 1, or road traffic network, is described below with reference to FIG. 1.

The road infrastructure 1 comprises at least one section of road, or roadway 3, over which at least one vehicle 5 may move. The vehicle 5 comprises a communicating box 7, for example of OBU (on-board unit) type.

The section of road 3 is for example a section of road comprising two traffic lanes 31, 33. The section of road 3 may also comprise more than two traffic lanes.

The road infrastructure 1 comprises at least one connected box or roadside unit (RSU) 9. The RSU 9 is located on the side of the roadway 3, for example on the side 3a. The RSU 9 has a fixed position which is known.

A plurality of RSUs 9 may be arranged on the side of the roadway 3, preferably in a regular manner, preferably on the same side of the roadway 3.

Advantageously, the section of road 3 may be equipped with a plurality of RSUs 9 arranged every 500 m to 1 km. This corresponds to the case of a road infrastructure 1 with massive deployment of RSUs.

The considered range of an RSU 9, in other words the distance to which the messages transmitted by the RSU may be broadcast, is for example of the order of 1000 meters, in theory.

Optionally, the road infrastructure 1 may further comprise a remote platform 11. The remote platform 11 comprises, for example, servers relating to constructors and/or traffic information providers and/or road infrastructure managers and/or content providers. This remote platform 11 allows the data received from the vehicles and/or the data to be sent to the vehicles to be processed.

Messages 20 comprising data may be exchanged between the communicating box 7 of each vehicle 5 and each RSU 9.

Messages 22 may be exchanged between each RSU 9 and the remote platform 11.

The signals processed or to be processed in the method described below, in particular the messages 20 exchanged between the RSUs 9 and the communicating boxes 7 of the vehicles 5, conform, for example, to the 802.11p Wi-Fi standard.

One embodiment of a method for locating a vehicle is described below with reference to FIG. 2.

The method for locating a vehicle comprises a step of determining a first estimate of the position of the vehicle on the basis of determining the relative position of the vehicle 5 with respect to a roadside unit 9 used as a first information source.

In a step E1 (FORM), the messages transmitted, for example periodically, by a roadside unit 9 are received. The messages 20 transmitted by a roadside unit 9 are received by the communicating box 7 of the vehicle 5. The roadside unit 9 corresponds to a first information source.

The reception of the messages 20 allows raw data to be obtained. The raw data are then formatted so that they may be used in the subsequent steps of the method.

In this step E1, only the data from messages transmitted by an RSU are taken into account. For this, a filtering according to the type of transmitting station may be performed in order to avoid taking into account information which does not come from an RSU, or which does not come from a single RSU. A filtering may also be performed according to the speed, to avoid taking into account mobile RSUs.

In a first step E10, the time t_{ref} required for the vehicle 5 to reach a reference position is determined.

In a first sub-step E101 (REF) of the first step E10, said reference position is determined. The reference position corresponds, for example, to the position of a reference point located in proximity to a roadside unit 9 whose position, for example in terms of longitude and latitude, is known. The reference position is calculated on the basis of the known and fixed position of a chosen roadside unit 9. Said reference position corresponds to the position at which the vehicle in question 5 is located the shortest possible distance away from the roadside unit 9.

In a second sub-step E102 (COMP) of the first step E10, the current position of the vehicle and/or the speed in real time of the vehicle and/or the direction of movement of the vehicle are determined.

Information, or data, obtained in step E1 from the first information source or roadside unit 9 may be used for this. On the basis of the reception, by the communicating box 7, of messages transmitted by said roadside unit 9, it is possible to obtain first data providing a first current position of the vehicle and/or a first speed in real time of the vehicle and/or a first direction of movement of the vehicle.

It is also possible to use information, or data, obtained from at least a second information source (UBMOD), in a step E2. On the basis of the reception of messages transmitted by said at least a second information source, it is possible to obtain second data comprising a second current position of the vehicle and/or a second speed in real time of the vehicle and/or a second direction of movement of the vehicle. This second information source may, for example, be a location system of GNSS type.

The first data obtained from the first information source or RSU 9 by the communicating box 7 are compared with the second data obtained from the at least a second information source. These first and second data are processed. The first and second data are transmitted in real time by the first and the second information sources. These first and second data are, for example, retrieved in the form of a data structure, by using in particular software of ROS (Robot Operating System) type. The first and second current positions of the vehicle are in particular provided, respectively, by the first and second information sources as coordinates expressed in terms of longitude and latitude (in degrees). To be able to compare the first and second current positions of the vehicle by observing, in a straightforward manner, the differences between the first and second positions, the coordinates expressed in terms of longitude and latitude are in particular converted into Cartesian coordinates (in meters) in the UTM (Universal Transverse Mercator) coordinate system. A final step of processing the first and second data may include selecting the information source whose journey history appears to be the most consistent. The current position of the vehicle, the speed in real time of the vehicle and the direction of movement of the vehicle are obtained.

In a third sub-step E103 (CALC) of the first step E10, the time t_{ref} required for the vehicle 5 to reach said reference position is determined.

For this, said reference position determined beforehand in the first sub-step E101, and the current position, the speed in real time and the direction of the vehicle, obtained in sub-step E102, are used. The time t_{ref} required for the vehicle 5 to reach said reference position is then calculated.

The time t_{ref} required for the vehicle 5 to reach said reference position corresponds to a first input datum for the algorithm for estimating the position of the vehicle with respect to the position of a roadside unit, in the step E40.

In a second step E20 (PROC), the minimum distance dₘᵢₙ between the vehicle 5 and the roadside unit 9 is determined.

For this, the reception, by the communicating unit 7 of the vehicle 5, of messages transmitted by said roadside unit, in step E1 described above, is used. At least one type of data obtained from the first information source corresponding to a roadside unit 9 is used and this type of data is referred to by the term “location data”.

Preferably, in step E20, the location datum used is the indicator of power of the received radio signal, referred to by the acronym RSSI (Radio Signal Strength Indicator).

The communications between the RSUs 9 and the vehicles 5 may be performed according to the 802.11p Wi-Fi standard, usually used for smart transport systems. This makes it possible to obtain the RSSI of the Wi-Fi signal as a location datum.

In step E1, the power of the signal transmitted by the roadside unit 9 is measured by the communicating box 7.

A plurality of messages 20 are transmitted over time, for example periodically, by a roadside unit 9, for example at a frequency of ten messages per second. In step E20, the variation in the RSSI as a function of time is used to calculate the minimum distance dₘᵢₙ between said vehicle 5 and the roadside unit 9.

The RSSI increases as the vehicle 5 approaches said roadside unit 9 and decreases as the vehicle 5 moves away from said roadside unit 9. The value of the RSSI is maximum when said vehicle 5 is at a minimum distance dₘᵢₙ from the roadside unit 9.

In step E20, the minimum distance dₘᵢₙ from the vehicle 5 with respect to the roadside unit 9 is therefore determined on the basis of the variation in the RSSI, the minimum distance dₘᵢₙ being the distance between said vehicle and the roadside unit for which the value of the RSSI is maximum.

Preferably, to calculate the minimum distance dₘᵢₙ on the basis of the maximum value of the RSSI, the power of the signal carrying the messages may be measured. The minimum position dₘᵢₙ of the vehicle with respect to said roadside unit is deduced from the detection of a maximum power reached by said signal.

Advantageously, the data recordings are carried out under free space conditions, or in a space comprising little interference. As a variant, in a space comprising interference, for example due to the presence of urban canyons and/or large buildings, the propagation model may be estimated on the basis of a sufficiently high number of acquisitions.

The distance dₘᵢₙ may be calculated on the basis of the FRIIS formula (telecommunications equation):

$$\frac{{P}_{r}}{{P}_{t}} = {G}_{t} . {G}_{r} . {( \frac{λ}{4 \cdot ττ \cdot R} )}^{2}$$

with Pᵣ the reception power of the signal, Pₜ the transmission power of the signal, Gₜ and Gᵣ the transmission and reception gains, respectively, A the wavelength of the signal and R the distance between the transmitter and the receiver. The transmitter corresponds to the RSU 9 and the receiver corresponds to the communicating box 7 of the vehicle 5. The distance R corresponds to the distance between the RSU 9 and the vehicle 5.

As may be seen in this equation, the reception power of the signal is higher the closer together the transmitter and the receiver are. The minimum position dₘᵢₙ of the vehicle 5 with respect to said roadside unit 9 is therefore deduced from the detection of a maximum power reached by said signal.

At the time for which the distance between the vehicle 5 and the roadside unit 9 is minimum and equal to dₘᵢₙ said vehicle 5 may be located in a circle whose radius is the minimum distance dₘᵢₙ between said vehicle and the roadside unit, and whose center is the position of the roadside unit 9. Such a circle is hereinafter referred to as the “circle of uncertainty”.

In step E20 of estimating the relative position of the vehicle with respect to said roadside unit, it is considered that, when the signal reaches the maximum power, the vehicle is located on the road on the side of which the RSU is known to be installed, at the point on this road closest to said RSU.

The minimum distance dₘᵢₙ corresponds to a second input datum for the algorithm for estimating the position of the vehicle with respect to the position of a roadside unit, in step E40.

In a third step E30, a filtering is performed, in particular with respect to a map (MAP). Knowing the position of the RSU 9 on the map and the topology of the road, it is possible to determine on which portion of the road the vehicle is located and thus filter part of the circle of uncertainty obtained in the second step E20.

The third step E30 makes it possible to refine the estimate of the location of the vehicle in said circle obtained in step E20, the radius of which is the minimum distance dₘᵢₙ between said vehicle and the roadside unit, and the center of which is the position of the roadside unit 9, for example by virtue of the information provided by the map on the relative position of the road with respect to this circle.

The information from the map corresponds to a third input datum for the algorithm for estimating the position of the vehicle with respect to the position of a roadside unit, in step E40.

As a variant, the filtering step E30 may be performed without the use of a map. In this variant, each point of the circle of uncertainty is compared with said reference position determined in the first sub-step E101 (REF) of the first step E10, then the one or more points closest to this reference position are selected.

In a fourth step E40 (ESTIM), the relative position of the vehicle 5 with respect to the position of a roadside unit 9 is determined. For this, the results of steps E10, E20 and E30 are combined in order to deduce the position of the vehicle therefrom. The position of the vehicle is determined on the basis of the time t_{ref} obtained in step E10, of the distance dₘᵢₙ obtained in step E20 and on the basis of the results of step E30.

Step E40 makes it possible to determine a first estimate of the position of the vehicle. The first estimate is, for example, determined with an accuracy of the order of 0.01 degrees of deviation with respect to the reference position in terms of latitude and of the order of 10⁻⁷ degrees of deviation with respect to the reference position in terms of longitude.

The first estimate obtained in step E40 makes it possible to confirm or disconfirm that said vehicle 5 has indeed passed by said RSU 9.

The first estimate obtained in step E40 makes it possible to validate or invalidate at least a second estimate of the position of the vehicle provided by at least a second information source.

The at least a second information source may correspond to all of the modules for locating the vehicle, making it possible to provide at least a second estimate of the position of the vehicle.

The first estimate of the position of the vehicle obtained in step E40 makes it possible to consolidate, in other words to validate, verify, confirm or approve, the estimates provided by either or both of the information sources, in particular at least a second estimate of the position of the vehicle provided by at least a second information source.

In the event of a validation fault, a step of correcting the data provided by the one or more other information sources may be implemented.

One advantage of a method of the type described with reference to FIG. 2 lies in the fact that it uses roadside units which are already existing road infrastructures, which makes it possible to decrease the costs of implementation.

Another advantage of a method of the type described with reference to FIG. 2 lies in the fact that it makes it possible to improve the accuracy of the location of the vehicle, by virtue of the use of an additional information source with respect to the usual systems for locating the vehicle.

Another advantage of a method of the type described with reference to FIG. 2 lies in the fact that it makes it possible to improve the reliability of the location of the vehicle, by providing a first estimate of the position of the vehicle which makes it possible to validate at least a second estimate of the position of the vehicle provided by the usual systems for locating the vehicle. As a result, it may be used to provide increased safety in the circulation of autonomous vehicles.

A method for locating a vehicle has been described with reference to FIG. 2 in which, in the second step E20, the RSSI is used as the location datum provided by the first information source corresponding to the roadside unit. As a variant, other location data could be used to determine the minimum distance dₘᵢₙ between the vehicle and an RSU, for example the times of arrival or the differences in times of arrival of the signals.

A method for locating a vehicle has been described with reference to FIG. 2 in which, in a second sub-step E102 of the first step E10, the current position of the vehicle and/or the speed in real time of the vehicle and/or the direction of movement of the vehicle are determined on the basis of comparing first data obtained from a roadside unit corresponding to a first information source and second data obtained from at least a second information source. As a variant, in the second sub-step E102 of the first step E10, the current position of the vehicle, the speed in real time of the vehicle and the direction of movement of the vehicle may be determined only on the basis of data obtained by the communicating box from a roadside unit, in step E1. According to another variant, in the second sub-step E102 of the first step E10, the current position of the vehicle, the speed in real time of the vehicle and the direction of movement of the vehicle may be determined only on the basis of data obtained from the at least a second information source, in step E2.

One example of a vehicle 5 comprising one embodiment of a communicating box 7 is described below with reference to FIG. 3.

The communicating box 7 comprises the hardware and/or software elements that make it possible to implement the steps of a method for locating a vehicle such as that described above with reference to FIG. 2. These various elements may comprise software modules.

For example, the hardware and/or software elements may comprise all or some of the following elements:
an antenna 71 intended to receive messages transmitted by a roadside unit 9;
a receiver 72;
a power sensor 73 for the signal carrying the messages;
a computer 74;
a memory 75.

The vehicle 5 advantageously comprises a second information source 78, in particular a GPS location system, and a map database 79.

As a variant, either or both of the second information source 78 and the map database 79 may be included in the communicating box 7.

1-17. (canceled)

18. A method for locating a vehicle, comprising:
determining a first estimate of a position of the vehicle based on determining a relative position of the vehicle with respect to a roadside unit used as a first information source, said first estimate of the position of the vehicle being used to validate at least a second estimate of the position of the vehicle provided by at least a second information source.

19. The method as claimed in claim 18, wherein the determining the first estimate of the position of the vehicle comprises receiving by the vehicle of at least one message transmitted by said roadside unit.

20. The method as claimed in claim 19, wherein the receiving comprises:
obtaining raw data; and
formatting the raw data.

21. The method as claimed in claim 19, wherein the receiving further comprises filtering so as to take into account only the messages transmitted by a roadside unit.

22. The method as claimed in claim 19, wherein the determining the first estimate of the position of the vehicle further comprises:
measuring a power of the signal carrying the message; and
determining the relative position of the vehicle with respect to said roadside unit based on detecting a maximum power reached by said signal.

23. The method as claimed in claim 22, wherein the determining the relative position of the vehicle with respect to said roadside unit includes considering that, when the signal reaches the maximum power, the vehicle is located on a road on a side of which the roadside unit is known to be installed, at a point on the road closest to said unit.

24. The method as claimed in claim 22, wherein the power of the signal carrying the messages is measured so as to determine a minimum distance from the vehicle with respect to the roadside unit.

25. The method as claimed in claim 22, wherein a RSSI of the signal is used as a location datum for the vehicle.

26. The method as claimed in claim 18, wherein the determining the first estimate of the position of the vehicle comprises determining a time required for the vehicle to reach a reference position.

27. The method as claimed in claim 26, wherein the determining the time required for the vehicle to reach the reference position comprises:
determining a reference position corresponding to the position at which the vehicle is located a shortest possible distance away from the roadside unit;
determining a current position, a speed in real time, and a direction of the vehicle; and
calculating the time required for the vehicle to reach said reference position, based on said reference position, by considering the current position, the speed in real time, and the direction of the vehicle.

28. The method as claimed in claim 27, wherein the determining the current position, the speed in real time, and the direction of the vehicle comprises:
obtaining first data comprising a first current position and/or a first speed in real time and/or a first direction of the vehicle, based on receiving messages transmitted by said roadside unit;
receiving messages transmitted by at least a second information source, making it possible to obtain second data comprising a second current position and/or a second speed in real time and/or a second direction of the vehicle; and
comparing the first data obtained from said roadside unit and the second data obtained from the at least a second information source, making it possible to determine the current position of the vehicle and/or the speed in real time of the vehicle and/or the direction of the vehicle, or to construct the current position of the vehicle and/or the speed in real time of the vehicle and/or the direction of the vehicle, according to the first and second data.

29. The method as claimed in claim 18, wherein the determining the first estimate of the position of the vehicle comprises filtering.

30. The method as claimed in claim 18, wherein the determining the first estimate of the position of the vehicle comprises filtering with respect to a map.

31. The method as claimed in claim 18, wherein the information provided by the first information source conforms to the 802.11p Wi-Fi standard.

32. A communicating box configured to be used in a vehicle, the communicating box comprising:
hardware and/or software elements configured to implement the method as claimed in claim 18.

33. A non-transitory data storage medium, readable by a computer, on which is stored a computer program comprising program code instructions for implementing the method as claimed in claim 18.

34. A vehicle comprising the communicating box as claimed in claim 32.

35. A vehicle comprising the data storage medium as claimed in claim 33.
